(19) United States
(12) Patent Application Publication
(10) Pub. No.: US 2011/0102998 A1
(43) Pub. Date: May 5, 2011

(54) DISK DRIVE ASSEMBLY AND ELECTRONIC DEVICE HAVING THE SAME

(75) Inventors: MENG-HSIEN LIN, Tu-Cheng (TW); YU-CHIA LAI, Tu-Cheng (TW); YAO-TING CHANG, Tu-Cheng (TW)

(73) Assignee: HON HAI PRECISION INDUSTRY CO., LTD., Tu-Cheng (TW)

(21) Appl. No.: 12/630,859

(22) Filed: Dec. 4, 2009

(30) Foreign Application Priority Data
Oct. 30, 2009 (CN) 200910309166.0

(51) Int. Cl. G06F 1/16

(52) U.S. Cl. 361/679.33

(57) ABSTRACT

A disk drive assembly includes a disk drive, a carrier containing the disk drive and a pad. The carrier includes a bottom frame and two opposite sidewalls connected to two opposite edges of the bottom frame. The pad is sandwiched between the disk drive and each of the two sidewalls.

### BACKGROUND

1. Technical Field

The disclosure relates to disk drive assemblies and, particularly, to a disk drive assembly having heat dissipation structure and an electronic device having such a disk drive assembly.

2. Description of Related Art

To support processors and software, capacities of hard disks have increased from megabytes to gigabytes, and the read-write speeds have become faster and faster.

As a result, hard disks generate a lot of heat and temperatures of the hard disks may rise quickly. If the heat of the hard disks can not be rapidly dissipated, the hard disks may function poorly or even be damaged.

What is needed, therefore, is a hard disk assembly having heat dissipation structure and an electronic device having such a hard disk assembly.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled view of a disk drive assembly in accordance with an exemplary embodiment of the disclosure.

FIG. 2 is an isometric, exploded view of the disk drive assembly shown in FIG. 1.

FIG. 3 is an enlarged, partial, cross-sectional view of a combination of the disk drive assembly shown in FIG. 1. and an electronic device, taken along line III-III of FIG. 1.

### DETAILED DESCRIPTION

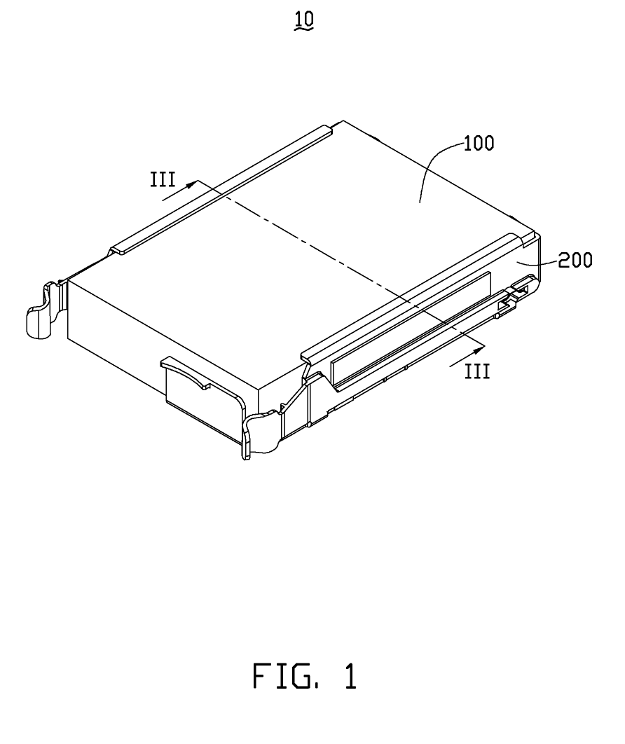

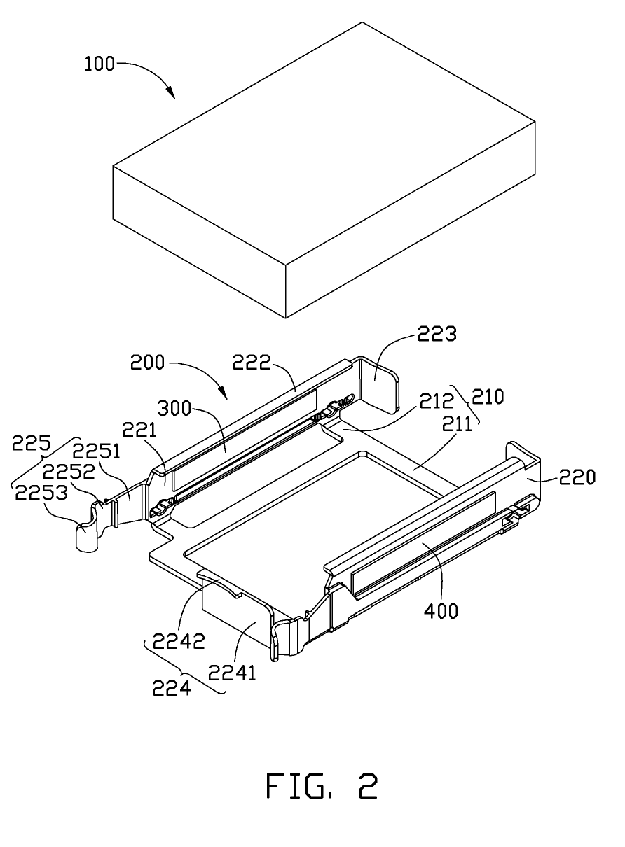

Referring to FIGS. 1-2, an exemplary embodiment of a disk drive assembly 10 includes a disk drive 100 and a carrier 200 containing the disk drive 100. The carrier 200 may be made of a pliable material such as certain plastics, and integral to the structure of the carrier 200 are a bottom frame 210 and two opposite sidewalls 220 connected to two opposite edges of the bottom frame 210. The bottom frame 210 and the two sidewalls 220 cooperatively define a space for receiving the disk drive 100.

The bottom frame 210 includes a base 211 connected to the two sidewalls 220 by a number of connecting portions 212. In the present embodiment, two connecting portions 212 extend horizontally and outwardly from two opposite sides of a rear end of the base 211, and another two connecting portions 212 extend horizontally and outwardly from two opposite sides of a front end portion of the base 211. It is understood that structures and number of the connecting portions 212 are not limited, so long as they can connect the two sidewalls 220 to the two opposite edges of the bottom frame 210.

Each of the two sidewalls 220 includes an elongated plate 221, a resisting plate 222, a first baffling plates 223, and a clipping part 225. The plate 221 is a flat plate, and a bottom edge of the plate 221 is connected to the two connecting portions 212 of a corresponding edge of the base 211. The resisting plate 222 horizontally and inwardly extends from a top edge of the plate 221. The resisting plate 222 is also an elongated plate as long as or shorter than the plate 221. Two resisting parts 222 of the two lateral walls 220 are spaced apart from each other by a predetermined distance to define an entrance for the disk drive 100 being inserted into the carrier 200. When the disk drive 100 is received in the carrier 200, the two resisting parts 222 resist against a top surface of the disk drive 100.

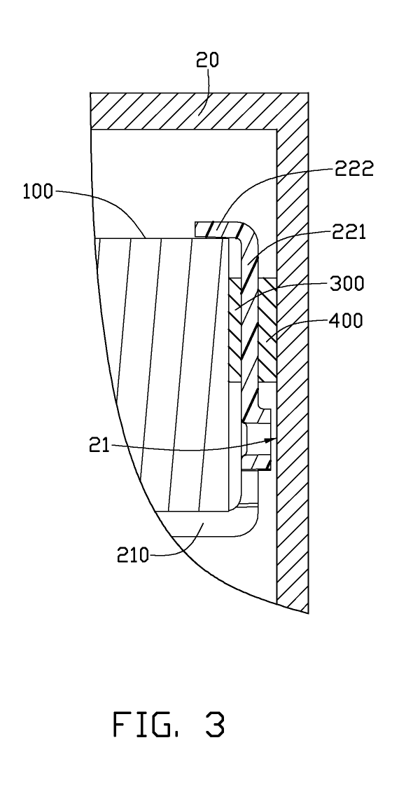

Each of the two first baffling plates 223 extends inwardly from the rear end of the plate 221 of each of the two side walls 220, and therefore two first baffling plates 223 are formed at two rear ends of the two lateral walls 220. The two first baffling plates 223 are spaced apart from each other by a certain distance and are perpendicular to the plate 221. When the disk drive 100 is received in the carrier 200, the two first baffling plates 223 resist against a rear surface of the disk drive 100. A second baffling plate 224 has an L-shaped configuration, and includes an extension section extending forward the front end of the base 211, a baffling section 2241 extending upwardly from a free end of the extension section, and an operation section 2242 extending outwardly from a top edge of the baffling section 2242. The baffling section 2241 of the second baffling plate 224 and the two first baffling plates 223 cooperatively prevent the disk drive 100 from moving forward and backward on the carrier 200. The operation section 2242 is configured for easily pulling or pushing the disk drive assembly 10 from or into an enclosure 20 (the enclosure 20 is shown in FIG. 3 and will be described in the following) of an electronic device (not shown). In the present embodiment, heights of the two first baffling plates 223 and the second baffling plate 224 are equal to or slightly less than heights of the two sidewalls 220. The second baffling plate 224 is half as long as a width of the base 211, and the second baffling plate 224 is connected to a side of the front end of the base 211 along a widthwise direction of the base 211.

The clipping part 225 is configured for securing the disk drive assembly to the enclosure 20 of the electronic device. The clipping part 225 includes a plate-like extending section 2251 extending forward from a front end of the plate 221, an engaging section 2252 extending forward from a free end of the extending section 2251, and a handle 2253 connected to a free end of the engaging section 2252. The engaging section 2252 is an arc-shaped sheet, which extends outwardly and protrudes from the extending section 2251. The handle 2253 is a sheet and extends outwardly from the engaging section 2252. The engaging section 2252 and the handle 2253 cooperatively form an S-shaped configuration with certain elasticity. The engaging sections 2252 of the two clipping parts 225 of the two sidewalls 220 are configured to be received in two opposite grooves of the enclosure 20 of the electronic device, thereby securing the disk drive assembly to the enclosure 20 of the electronic device.

In assembling the disk drive assembly to the enclosure 20 of the electronic device, the two handles 2253 are pressed inwardly to enable the two engaging sections 2252 deform inwardly, and the disk drive assembly slides inwardly along a lengthwise direction of the enclosure 20 of the electronic device to reach a predetermined position, then the two handles 2253 are released to enable the two engaging sections 2252 reform outwardly and engage respectively in the two grooves of the enclosure 20 of the electronic device. In disassembling the disk drive assembly from the enclosure 20, the two handles 2253 are pressed inwardly to enable the two engaging sections 2252 deform inwardly, as a result, the two engaging sections 2252 disengage with the two grooves of the enclosure 20 of the electronic device. Then the disk drive assembly can be drawn out of the enclosure 20 of the electronic device by being slid outwardly along a lengthwise direction of the enclosure 20 of the electronic device.

Due to the carrier 200 having an integral configuration and being made of the pliable material, the carrier 200 has a flexible characteristic to allow a kind of snapping engagement with the disk drive 100. In securing the disk drive 100 to the carrier 200, the disk drive 100 is directly inserted into the house of the carrier 200 by being passed through the entrance defined by the two resisting plates 222 of the two sidewalls 220. Due to their flexibility, the two sidewalls 220 deform outwardly first and then reform inwardly, whereby the disk drive 100 is sandwiched between the two sidewalls 220. Under a combination action of the first and second baffling plates 223, 224, a movement of the disk drive 100 between the front and rear ends of the carrier 200 can be restricted. It is understood that the disk drive 100 is not limited to be directly inserted into the carrier 200. In an alternative embodiment, a number of screws can be extended through the two sidewalls 220 to abut against side surfaces of the disk drive 100, thereby stably fixing the disk drive 100 in the carrier 200.

Regarding the above-described manner for securing the disk drive 100 to the carrier 200. To ensure efficient heat dissipation and prevent vibration of the disk drive 100 in the carrier 200, a first pad 300 is applied between the plates 221 of two sidewalls 220 and the side surface of the disk drive 100 to eliminate gaps. In the present embodiment, the first pad 300 is disposed on an inner surface of the plate 221 of each of the two sidewalls 220, whereby the disk drive 100 can tightly contact the inner surfaces of the two plates 221. To aid in heat dissipation, the first pad 300 can be made of high heat conducting material, such as a heat conducting polymer, a heat conducting metal or a composite of the heat conducting polymer and heat conducting particles. The first pad 300 can be an elastic or rigid sheet. In the present embodiment, the first pad 300 is an elastic sheet made of the heat conducting polymer doped with heat conducting particles.

Heat generated by the disk drive 100 is transferred to the first pad 300 and the corresponding plate 221, and then dissipated out of the disk drive assembly 10, thereby avoiding heat accumulating in the disk drive assembly 10. In addition, the first pad 300 enables tight engagement of the disk drive 100 with the plate 221 of the sidewall 220, thereby avoiding annoying sounds that would be caused by vibration.

Referring to FIG. 3, the disk drive 10 is installed in the enclosure 20 of the electronic device. A second pad 400 is sandwiched between the plate 221 of at least one of the two sidewalls 220 and the enclosure 20. The second pad 400 is identical to the first pad 300, and the second pad 400 is disposed on an outer surface of the plate 221. Preferably, a position of the second pad 400 on the outer surface of the plate 221 is corresponding to a position of the first pad 300 on the inner surface of the corresponding plate 221. Thus, the heat generated by the disk drive 100 is sequentially transferred to the first pad 300, the plate 221, the second pad 400, the enclosure 20, and then dissipated out of the enclosure 20 of the electronic device, thereby avoiding heat accumulating in the enclosure 20. In addition, the second pad 400 enables tight engagement of the disk drive assembly 10 with the enclosure 20, thereby avoiding annoying sounds that would be caused by vibration.

It is to be understood, however, that even though numerous characteristics and advantages of the present embodiments have been set forth in the foregoing description, together with details of the configurations and functions of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A disk drive assembly comprising:
a disk drive;
a carrier containing the disk drive, the carrier comprising a bottom frame and two opposite sidewalls connected to two opposite edges of the bottom frame; and
a pad sandwiched between the disk drive and each of the two sidewalls.

2. The disk drive assembly of claim 1, wherein the pad is made of heat conducting material.

3. The disk drive assembly of claim 2, wherein the heat conducting material is selected from the group consisting of a heat conducting polymer, a heat conducting metal and a composite of the heat conducting polymer and heat conducting particles.

4. The disk drive assembly of claim 2, wherein the pad is an elastic or rigid sheet.

5. The disk drive assembly of claim 2, wherein each of the two sidewalls comprises an elongated plate, a resisting plate inwardly extending from a top edge of the plate, and a first baffling plate extending inwardly from a rear end of the plate; a second baffling plate extends upwardly from a front end of the bottom frame; the first baffling plate and the second baffling plate cooperatively prevent the disk drive from moving forward and backward in the carrier, the pad is sandwiched between a side surface of the disk drive and an inner surface of the plate of each of the two sidewalls, the resisting plates of the two sidewalls resist against a top surface of the disk drive.

6. The disk drive assembly of claim 5, wherein the two first baffling plates of the two sidewalls are spaced from each other by a predetermined distance.

7. The disk drive assembly of claim 5, wherein the second baffling plate has an L-shaped configuration, and comprises a baffling section extending upwardly from a front end of the bottom frame for abutting the disk drive, and an operation section extending outwardly from a top edge of the baffling section.

8. An electronic device comprising:
an enclosure;
a disk drive assembly installed in the enclosure, wherein the disk drive comprises a disk drive, a carrier and a first pad, the carrier comprises a bottom frame and two opposite sidewalls connected to two opposite edges of the bottom frame, the disk drive is supported on the bottom frame and arranged between the two sidewalls, the first pad is sandwiched between an inner surface of at least one of the two sidewalls and the disk drive; and
a second pad sandwiched between an inner surface of the enclosure and an outer surface of at least one of the two sidewalls of the carrier of the disk drive assembly.

9. The electronic device of claim 8, wherein the pad is made of heat conducting material.

10. The electronic device of claim 9, wherein the heat conducting material is selected from the group consisting of a heat conducting polymer, a heat conducting metal and a composite of the heat conducting polymer and heat conducting particles.

11. The electronic device of claim 9, wherein the pad is an elastic sheet or a rigid sheet.

12. The electronic device of claim 9, wherein each of the two sidewalls comprises an elongated plate, a resisting plate inwardly extending from a top edge of the plate, and a first baffling plate extending inwardly from a rear end of the plate; a second baffling plate extends upwardly from a front end of the bottom frame; the first baffling plate and the second baffling plate cooperatively prevent the disk drive from moving forward and backward in the carrier, the pad is sandwiched between a side surface of the disk drive and an inner surface of the plate of each of the two sidewalls, the resisting plates of the two sidewalls resist against a top surface of the disk drive.

13. The electronic device of claim 12, wherein the two first baffling plates of the two sidewalls are spaced from each other by a predetermined distance.

14. The electronic device of claim 12, wherein the second baffling plate has an L-shaped configuration, and comprises a baffling section extending upwardly from a front end of the bottom frame for abutting the disk drive, and an operation section extending outwardly from a top edge of the baffling section.
